(19) United States
(12) Patent Application Publication
(10) Pub. No.: US 2015/0204799 A1
(43) Pub. Date: Jul. 23, 2015

(54) COMPUTER-BASED DEFECT ROOT CAUSE AND YIELD IMPACT DETERMINATION IN LAYERED DEVICE MANUFACTURING FOR PRODUCTS AND SERVICES

(71) Applicant: International Business Machines Corporation, Armonk, NY (US)

(72) Inventors: Benjamin R. Cipriany, Wappingers Falls, NY (US); Julie L. Lee, Wappingers Falls, NY (US)

(73) Assignee: International Business Machines Corporation, Armonk, NY (US)

(21) Appl. No.: 14/159,478

(22) Filed: Jan. 21, 2014

(51) Int. Cl. G01N 21/95; G06F 17/50

(52) U.S. Cl. CPC G01N 21/9501; G06F 17/5009; G01N 2201/12

(57) ABSTRACT

A method for evaluating a defect in a device manufactured by a layering process includes generating, with a processing device, a first virtual defect in a first simulated model of the device, and simulating a first manufacturing process associated with the device, wherein the first virtual defect is structurally transformed into a first evolved defect at least in part by the first manufacturing process.

### BACKGROUND

The present invention relates generally to layered manufacturing processes, and more specifically, to simulation of semiconductor or other layered device defects and their root cause determination and yield impact.

Identification of the root cause of semiconductor or other layered manufacturing process anomalies at the earliest possible stage is important in order to permit mitigation actions. Initial detection of a manufacturing process anomaly typically occurs at a downstream manufacturing stage from the initiation of the anomaly. Methods currently are available to inspect semiconductor wafers in an attempt to detect, categorize and report defects. Methods currently available to find the root cause of a detected anomaly in semiconductor or layered manufacturing typically involve partitioning multiple hardware samples for visual inspection at an specified range of manufacturing process steps. Defect root cause is estimated by monitoring at multiple downstream manufacturing stages for drive back or physical failure analysis and implementing fishbone analysis.

Methods are available to simulate circuit-level functional degrades, or failures, for large functional blocks of semiconductor or electrical devices in an attempt to assess the probable circuit-level impact of yield degradation. Other methods are available that compare a defect layout with a circuit-level layout in an attempt to identify overlapping regions that can result in electrical open- or short-circuits. Other methods are available that modify the design shape or size of a circuit layout to estimate sensitivity to non-overlapping and overlapping areas that could cause defect modes. Other methods are available that simulate a two-dimensional defect on a wafer profile during a single process step. Other methods are available to inspect and study defects in lithographic photomasks, or reticles.

### SUMMARY

According to one embodiment of the present invention, a method for evaluating a defect in a device manufactured by a layering process includes generating, with a processing device, a first virtual defect in a first simulated model of the device, and simulating a first manufacturing process associated with the device, wherein the first virtual defect is structurally transformed into a first evolved defect at least in part by the first manufacturing process.

According to another embodiment of the present invention, a system for evaluating a defect in a device manufactured by a layering process includes a virtual defect generator configured to generate a first virtual defect in a first simulated model of the device, and a process simulator configured to simulate a first manufacturing process associated with the device, wherein the first virtual defect is structurally transformed into a first evolved defect at least in part by the first manufacturing process.

According to yet another embodiment of the present invention, a computer program product for evaluating a defect in a device manufactured by a layering process, the computer program product includes a computer readable storage medium having stored thereon first program instructions executable by a processor to cause the processor to generate a first virtual defect in a first simulated model of the device, and second program instructions executable by a processor to cause the processor to simulate a first manufacturing process associated with the device, wherein the first virtual defect is structurally transformed into a first evolved defect at least in part by the first manufacturing process.

Additional features and advantages are realized through the techniques of the present disclosure. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic diagram of a defect simulator in accordance with an embodiment of the invention.

FIG. 2A is an illustration of a virtual defect in a simulated model of a semiconductor device in accordance with an embodiment of the invention.

FIG. 2B is an illustration of the defect after a simulated manufacturing process has been performed on the semiconductor device in accordance with an embodiment of the invention.

FIG. 2C is an illustration of the defect after additional simulated manufacturing processes have been performed on the semiconductor device in accordance with an embodiment of the invention.

FIG. 3A is an illustration of the virtual defect at another location in the simulated model of a semiconductor device in accordance with an embodiment of the invention.

FIG. 3B is an illustration of the defect after a simulated manufacturing process has been performed on the semiconductor device in accordance with an embodiment of the invention.

FIG. 3C is an illustration of the defect after additional simulated manufacturing processes have been performed on the semiconductor device in accordance with an embodiment of the invention.

FIG. 4 is a flow diagram of a method in accordance with an embodiment of the invention.

FIG. 5A is an illustration of a virtual defect in a simulated model of a semiconductor device in accordance with an embodiment of the invention.

FIG. 5B is an illustration of the defect after a simulated manufacturing process has been performed on the semiconductor device in accordance with an embodiment of the invention.

FIG. 5C is an illustration of the defect after additional simulated manufacturing processes have been performed on the semiconductor device in accordance with an embodiment of the invention.

FIG. 6A is an illustration of another virtual defect in the simulated model of a semiconductor device in accordance with an embodiment of the invention.

FIG. 6B is an illustration of the defect after a simulated manufacturing process has been performed on the semiconductor device in accordance with an embodiment of the invention.

FIG. 6C is an illustration of the defect after additional simulated manufacturing processes have been performed on the semiconductor device in accordance with an embodiment of the invention.

### DETAILED DESCRIPTION

An embodiment of the present invention may create a virtual environment for semiconductor or layered manufacturing anomaly root-cause and yield determination. An embodiment may facilitate identification of the initial cause of a semiconductor wafer defect by utilizing computer software simulation techniques to model the introduction of a process error in a semiconductor or other layered manufacturing process step, along with the propagation of the resulting defect through subsequent manufacturing process steps, in order to determine if the simulated error may develop into the defect.

For example, an embodiment may simulate the targeted introduction of a device-level process defect in a semiconductor foundry manufacturing process and assess the downstream process yield impact of the defect in later stages of the manufacturing process. An embodiment may simulate the placement of an arbitrary defect structure on a semiconductor wafer or other layered device at the point of root cause in a process flow, and evaluate the downstream processing implications regarding the semiconductor wafer or layered device processing yield.

An embodiment may simulate the placement of a three-dimensional (3D or 3-D) physical defect of arbitrary shape or topology on a 3D structural model, and compile, or propagate, the simulated defect through multiple processing steps. An embodiment may simulate defects in a three-dimensional solid model of an integrated process flow and identify process-driven failure modes that occur throughout the added dimension of wafer thickness, as compared to a two-dimensional model.

An embodiment may apply generally to solid model simulators, supporting both structural and structural-physics simulation models. An embodiment may enable the simulated exploration of multiple yield degradations or failures resulting either simultaneously or sequentially from a localized defect that interacts with multiple structural elements through multiple processing steps.

An embodiment may create a simulated defect layout in which the order, or sequence, of processing operations may influence the size and structural topology of the defect as it evolves through sequential manufacturing processes. In an embodiment, the simulated interaction of the defect with the intended structure may result in simulated structural variations that ultimately may affect material placement, localized internal stress and strain, structural integrity, incremental variations in electrical continuity, as well as multiple interdependent structural-functional failure mechanisms.

An embodiment may incorporate a simulated defect shape in a lithographic photomask design, and implement the defective mask in a virtual fabrication process to explore process-defect interactions and perform root-cause process failure analyses.

An embodiment may simulate a defect in any device produced by a multistep, layered manufacturing process. For example, various embodiments may simulate defects in layered devices produced by semiconductor or other layered manufacturing processes, layered manufacturing, additive manufacturing, laminated object manufacturing, rapid prototyping, directed self-assembly, chemical vapor deposition, three-dimensional printing, or the like.

Numerous types of layered fabrication techniques are known in the art. For example, layered processing may refer to an ordered flow of processing steps that assemble 1D/2D/3D structures by manufacturing techniques which sequentially add, remove or assemble a material layer on a substrate. Manufacturing techniques can be broadly defined as bottom-up and top-down fabrication. Specific examples of top-down fabrication techniques known in the art include: photolithography, thin films etching (ion milling, reactive ion etching [RIE], and chemical etching), chemical and mechanical polishing, chemical and physical vapor deposition, and surface micromachining. Specific examples of bottom-up fabrication include: selective growth, inorganic and organic synthesis, and directed self-assembly.

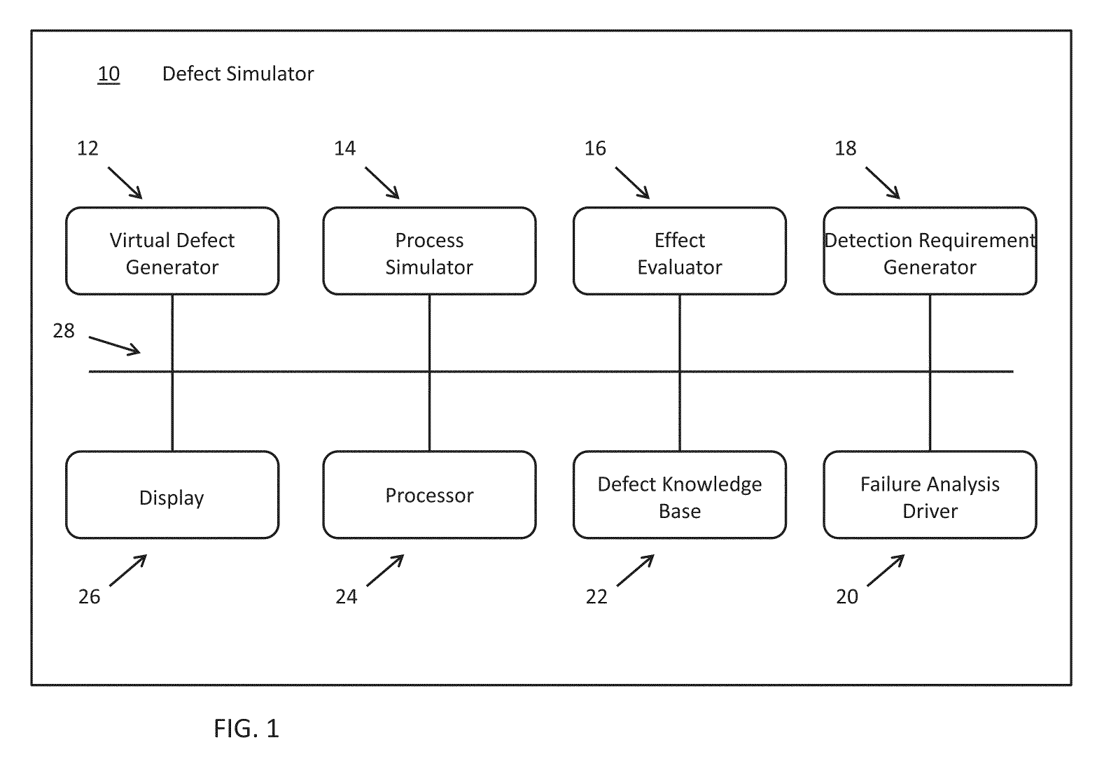

Referring now to FIG. 1, a defect simulator 10 in accordance with the present invention may include a virtual defect generator 12, a process simulator 14, an effect evaluator 16, a detection requirement generator 18, a failure analysis driver 20, a defect knowledge base 22, a processor 24, and a display 26, which may be communicatively connected by data links 28. The defect simulator 10 may provide a virtual environment for semiconductor or other layered manufacturing anomaly root cause and yield determination in which simulated defects may be introduced into a virtualized process flow for evaluation of both upstream and downstream manufacturing process effects on yield through feed-forward and feed-back considerations.

The data links 28 may include any connective media capable of transmitting digital data, as the specific application may require. For example, in any embodiment, the data links 28 may be implemented using any type of combination of known communications connections, including but not limited to digital data buses, a universal serial bus (USB), an Ethernet bus or cable, a wireless access point, twisted pairs of wires, or the like. In any embodiment, any portion or all of the data links 28 may be implemented using physical connections, radio frequency or wireless technology. A person of ordinary skill in the art will readily apprehend that any combination of numerous existing or future data communication technologies may be implemented in association with an embodiment of the invention.

The virtual defect generator 12 may be configured to generate, or create, a simulated initial physical defect. For example, the virtual defect generator 12 may draw, or delineate, the outline of the defect region, or defect mask, on the device layout file. The virtual defect generator 12 may mathematically describe, or define, the geometry of the defect material bounded by the defect region. The shape of the simulated initial defect is not required to by symmetrical about the defect mask, but rather, may an arbitrary shape. In an embodiment, the virtual defect type may be selected from a library of virtual defect types, for example, by a user selecting the defect type from a menu or dragging-and-dropping the virtual defect type in a graphical user interface.

The virtual defect generator 12 may replace the semiconductor wafer or other layered device material bounded by the defect region with the desired defect material, such as, for example, air in the case of an air bubble defect. In various embodiments, the material may include, but is not limited to, an organic material, a semiconductor material, such as silicon, or an insulator material, or another material used to manufacture the device. The defect material is not required to replace intersected features of the semiconductor wafer or layered device. In an embodiment, the simulated defect may be based on an actual defect, or defect of interest (DOI), that has been observed, or detected, in a semiconductor wafer or other layered device.

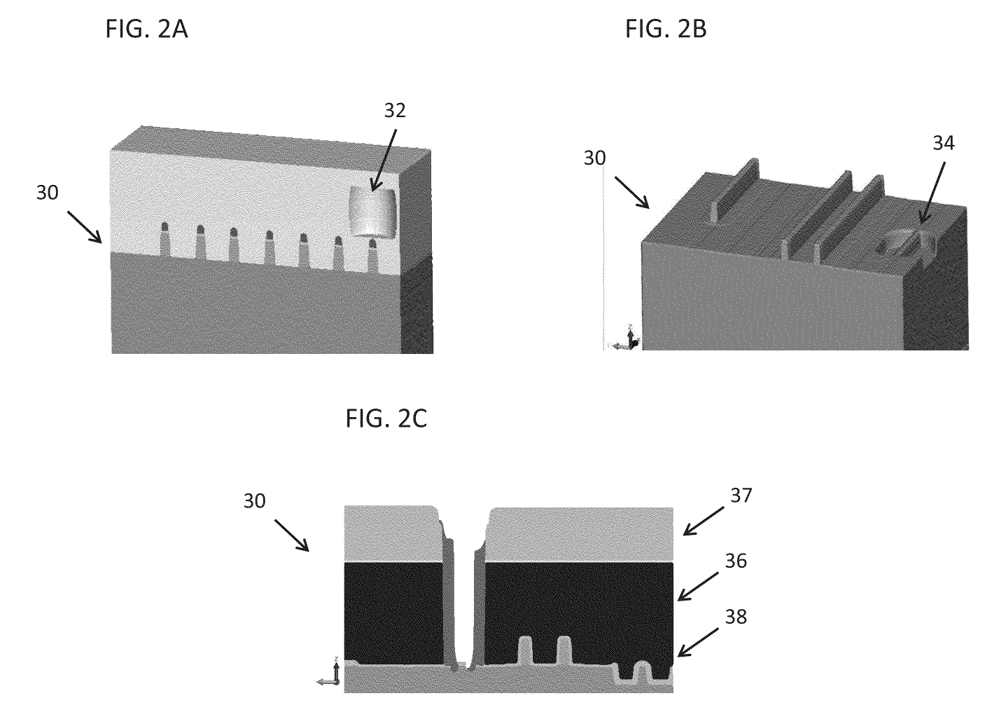

As a specific example, referring now to FIG. 2A, a simulated cross section of a complementary metal oxide semiconductor (CMOS) device 30 is shown. The virtual defect generator 12 may generate an initial virtual defect 32 in the device 30. For example, the virtual defect 32 may include a void, or air bubble, in an organic film layer near a fin on the device 30. The configuration of the device 30 and the virtual defect 32 may correspond to a specific stage, or module, of the semiconductor device manufacturing process.

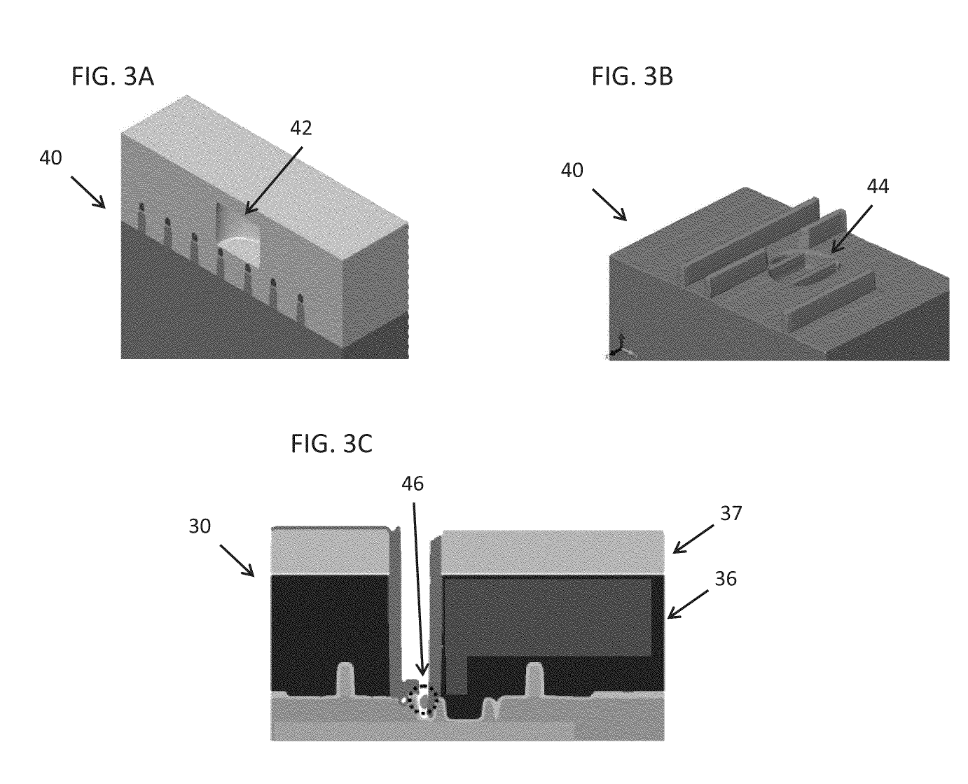

In addition, referring now to FIG. 3A, another simulated semiconductor device 40 is shown, which corresponds to the same design as the device 30 of FIG. 2A. The virtual defect generator 12 may generate another initial virtual defect 42 in the semiconductor device 40. For example, the virtual defect 42 may include the same shape void at a different location on the surface of the device 40. However, the virtual defect 42 may affect two fins, as opposed to the single fin affected by the virtual defect 32 in FIG. 2A, because the virtual defect 32 is at the edge of the device 30. In this example, the configuration of the device 40 and the virtual defect 42 correspond to the same stage, or module, of the manufacturing process as the virtual defect 32 of FIG. 2A.

Referring again to FIG. 1, the process simulator 14 may virtually incorporate, or insert, the simulated defect into the virtual process flow. For example, the process simulator 14 may insert the simulated defect at a manufacturing process step, or stage, upstream of the process step at which the actual defect was detected. The processor simulator 14 may simulate manufacturing process steps subsequent to the process step at which the simulated defect was inserted into the virtual process flow, but previous to the process step at which the actual defect was detected, in order to determine the effects of the process steps on the initial simulated defect.

The process simulator 14 may further simulate manufacturing process steps downstream of the process step at which the actual defect was detected in order to determine the effects of the subsequent process steps on the simulated defect.

In the example of FIG. 2A, the process simulator 14 may virtually incorporate, or insert, the virtual defect 32 at an upstream manufacturing process module. The process simulator 14 may simulate the removal of the organic film layer from the surface of the semiconductor device 30 at a subsequent stage of the manufacturing process, as shown in FIG. 2B, resulting in the evolved defect 34 on the surface of the semiconductor device 30. The process simulator 14 may further simulate the deposition of an insulator layer 36 and a metal layer 37 on the surface of the semiconductor device 30, as illustrated in FIG. 2C, resulting in the evolved defect 38.

Similarly, in the example of FIG. 3A, the process simulator 14 may virtually incorporate, or insert, the virtual defect 42 at the same upstream manufacturing process module, and simulate the removal of the organic film layer on the surface of the semiconductor device 40, as shown in FIG. 3B, resulting in the evolved defect 44. The process simulator 14 may further simulate the deposition of the insulator layer 36 and the metal layer 37 on the surface of the semiconductor device 40, as illustrated in FIG. 3C, resulting in the evolved defect 46.

Referring again to FIG. 1, the effect evaluator 16 may evaluate, or analyze, the effects of the eventual defect after one or more manufacturing process steps. For example, the effect evaluator 16 may evaluate the structural effects and functional impact of the defect at a particular phase, or module, of the manufacturing process. Similarly, the effect evaluator 16 may evaluate the yield impact of the eventual defect at completion of the manufacturing.

For example, in each of the examples of FIGS. 2A-2C and FIGS. 3A-3C, the simulated initial virtual defects 32, 42 evolve, or propagate, at each step of the manufacturing process. However, the simulated changes that result in the evolved defects 34, 38, 44, 46 in FIGS. 2B-2C and 3B-3C are different in each example, because the initial virtual defects 32, 42 are placed at different locations on the simulated semiconductor devices 30, 40.

As shown in FIG. 2C, following the subsequent manufacturing process steps, the evolved defect 38 on the simulated semiconductor device 30 results in minimal impact on the yield, because it is buried under the gate structure. The effect evaluator 16 may determine the virtual defect 32 is likely to cause only a small degradation in performance of the device 30, or possibly will cause no detectable degradation in performance. Thus, the effect evaluator 16 may determine the virtual defect 32 is not detrimental to the function of the device 30, because the evolved defect 38 has no significant electrical effect as a result of the structural perturbations at the location of the defect 32, 34, 38 on the semiconductor device 30 through the manufacturing process steps.

On the other hand, as shown in FIG. 3C, following the subsequent manufacturing process steps, the evolved defect 46 on the simulated semiconductor device 40 results in the growth of a significant wrap-around at the edge of a gate. The effect evaluator 16 may determine the virtual defect 42 is likely to cause a short circuit in the device 40, which would likely result in a critical failure mode of a functional test. Thus, the effect evaluator 16 may determine the virtual defect 42 is detrimental to the function of the device 40, because the evolved defect 46 has a critical electrical effect as a result of the structural perturbations at the location of the defect 42, 44, 46 on the semiconductor device 40 through the manufacturing process steps.

In an embodiment, simulated defects having various sizes, shapes and materials may be inserted at different stages, or steps, of the manufacturing process to evaluate and compare the resulting effects on the structure and function of the semiconductor device. In an embodiment, the simulated results may be compared with hardware test partitions from a corresponding manufacturing process step.

Referring once again to FIG. 1, the detection requirement generator 18 may define a detection, or inspection, requirement to be performed during a relatively early process step. For example, the detection requirement generator 18 may define a detection requirement during a manufacturing process subsequent to the simulated origination of the virtual defect based on the simulated defect evolution in order to detect actual defects as early as possible in the manufacturing process sequence.

The failure analysis driver 20 may determine an optimal cross-section of an actual semiconductor wafer or device to be partitioned during a manufacturing process step for a failure analysis inspection. For example, the simulated results of process steps upstream of an actual observed defect may be used to determine hardware partitions for spot inspections to verify the simulated results.

The simulated defect model may be stored in a defect knowledge base 22. For example, the simulated initial virtual defect characteristics and eventual structural and electrical effects may be stored for use in failure mode and effect analysis in related technologies.

Although the defect simulator 10 has been described with reference to semiconductor devices, a person of ordinary skill in the art will readily appreciate that various embodiments may be toward simulation of defects in any device manufactured by a layering process, including, but not limited to layered manufacturing, additive manufacturing, laminated object manufacturing, rapid prototyping, directed self-assembly, chemical vapor deposition, three-dimensional printing, or the like.

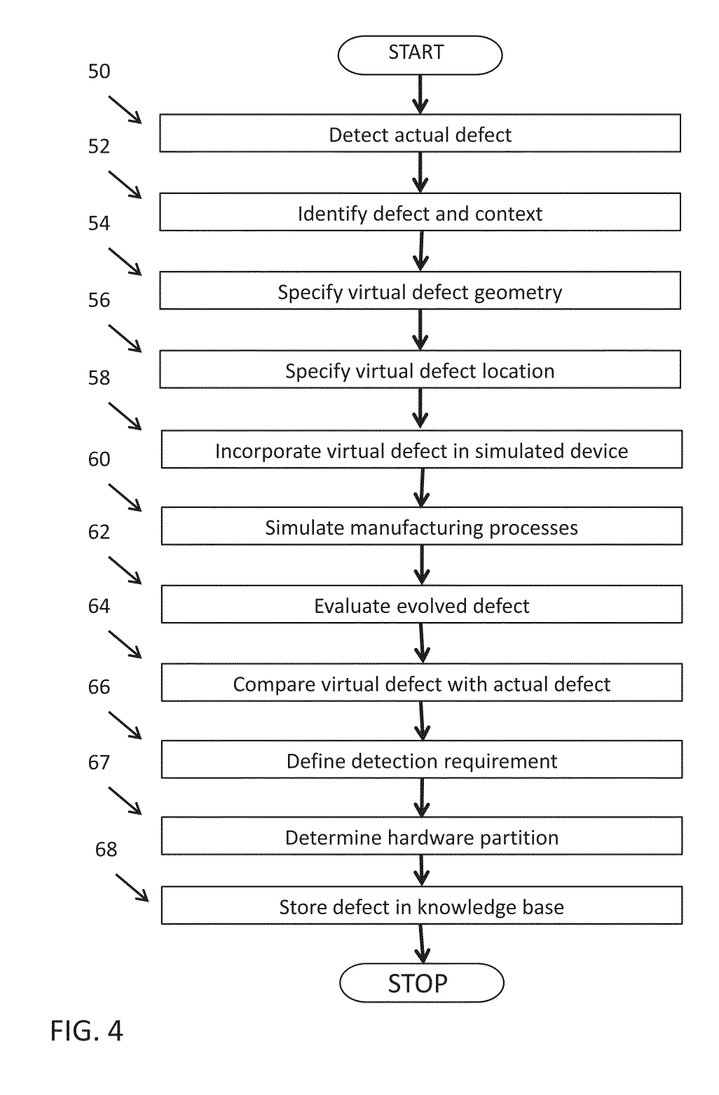

Referring now to FIG. 4, a flow chart depicting a method in accordance with an embodiment is shown. The method may be performed, for example, by the defect simulator 10 of FIG. 1. In block 50, an actual defect may be detected in a semiconductor or other layered device. For example, an actual defect may be observed in an inspection image taken during a manufacturing process step. In block 52, the type of defect and its context may be evaluated. For example, the size of the defect may be measured and the location of the actual defect with respect to the surface of the device may be identified. In an embodiment, the position of the defect with regard to the two-dimensional upper surface of the device may be determined on an image of the device surface.

In block 54, an initial virtual defect geometry, or type, may be specified for simulation. For example, an equivalent virtual defect that matches the observed defect may be selected from a library or menu of virtual defect types. The geometry of the virtual defect may be mathematically defined in three dimensional space. The geometry of the initial virtual defect may describe the shape, size and location of the defect. For example, a predetermined shape primitive selected from a library of various defect types may replace a film layer in the design feature. Alternatively, an equation, or equations, in an x, y, z coordinate system may be implemented to define the geometry of the defect. The definition of the virtual defect may be targeted to attempt to simulate the initiation and development of an actual detected defect. In block 56, the initial virtual defect location or region may be specified on a blueprint or layout drawing of the device to generate a defect mask.

In block 58, the virtual defect may be incorporated, or inserted, into the simulated device. For example, a design feature of a semiconductor wafer or layered device design, or layout, such as a semiconductor device gate, contact, interconnect, thin structure, or the like, may be selected for simulation. The design feature may correspond, for example, to the hardware feature in which the actual defect was detected. The original material, or materials, of the simulated semiconductor wafer or other layered device occupying the virtual defect region may be replaced with the defect material. For example, the original material in a hole defect region may be replaced with air. Similarly, the design material in an occlusion defect region may be replaced with the material of the occlusion, such as a metal, a metal oxide, or a foreign material.

In block 60, the initial virtual defect may be inserted into the simulation at a selected manufacturing process module, or stage, and one or more manufacturing process steps may be simulated. For example, the deposition of an organic film layer, a metal layer, a dielectric layer, or any other suitable layer may be simulated. Multiple manufacturing process steps may be sequentially simulated to represent any portion of the manufacturing process.

In block 62, the eventual effects of the evolution, or propagation, of the virtual defect during the simulated manufacturing process steps may be evaluated. For example, the structural topology of the evolved defect after passing through one or more manufacturing process steps may be studied. In addition, the electrical or functional effects of the evolved defect may be analyzed. In an embodiment, the potential yield impact of an observed defect may be evaluated after one or more subsequent simulated manufacturing process steps.

In an embodiment, the evaluation may be manually performed by a user visually inspecting a simulation visualization. In an embodiment, the evaluation may be performed in an automated manner, for example, by implementing a design rule checker.

In block 64, structural and functional effects of the virtual defect may be compared to those of the actual observed defect at the same or a similar manufacturing process phase to determine whether the simulated virtual defect inserted into the manufacturing process at the simulated origin point match the observed defect. The match may be evaluated to determine whether or not the virtual defect may represent the root cause of the observed defect.

In block 66, a detection requirement may be defined for a particular manufacturing process step based on the results of the virtual defect evaluation. For example, a detection requirement may be defined for a relatively early process step subsequent to the simulated origination of a virtual defect that is closely matched to the actual detected defect of interest at a later process step. For example, the simulation may dictate that a relatively high resolution imaging inspection be performed or a measurement be taken with an inline tool at a particular location of the semiconductor wafer or layered device during a manufacturing process relatively shortly after the source step of the virtual defect in order to detect actual defects as early as possible.

In block 67, a hardware partition may be determined for inspection. For example, the simulated results of upstream process steps may be used to determine an optimal cross-section of an actual semiconductor wafer or other layered device to be partitioned for a failure analysis inspection during a manufacturing process step. The defect model may be stored, for example, in a defect learning knowledge base, in block 68. For example, the simulated virtual defect characteristics and eventual structural and electrical effects may be stored for use in failure mode and effect analysis in related technologies.

An embodiment may iterate through multiple perturbations of modulated virtual defects, including size, shape, location, material characteristics, origin process, and the like. The ultimate structural effects and yield impact of each perturbation may be compared, for example, to an actual detected defect to match the detected defect to the probable characteristics of the initial virtual defect and origin process. That is to say, the method of FIG. 4, or portions of the method, may be repeated for multiple variations of hypothetical defects to determine which hypothesis is the probable cause of a detected defect. Thus, time-consuming and expensive successive approximation utilizing hardware samples may be reduced or eliminated.

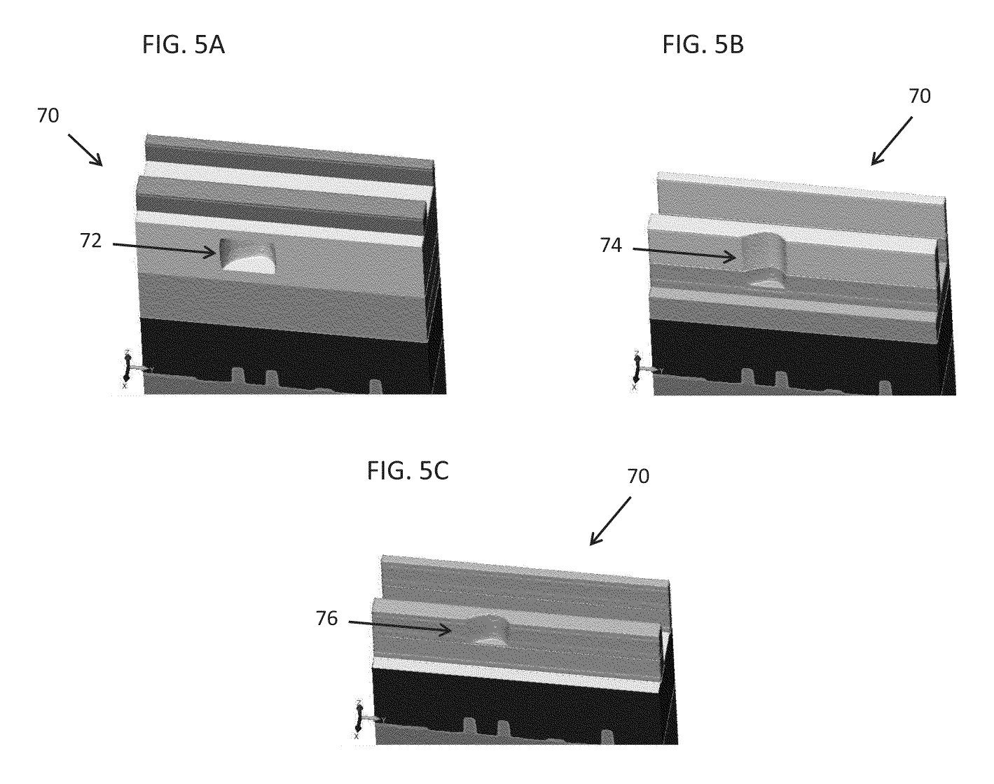

As a specific example, consider an exemplary investigation regarding a flop-over type defect randomly detected in a complementary metal oxide semiconductor (CMOS) device. The suspected cause of the flop-over is a bubble defect in a hard mask process. Referring to FIG. 5A, the actual defect may be detected in block 50 and its location on the imaged surface of the device may be identified in block 52. A simulated virtual bubble defect 72 may be introduced in a simulated CMOS device 70 in blocks 54-62 of FIG. 4. The device 70 may be virtually inserted into a particular manufacturing process module and manufacturing process steps may be simulated in block 62 of FIG. 4, resulting in the evolution of the bubble defect 74, 76 shown in FIGS. 5B and 5C. Evaluation of the effects of the evolved bubble defect 76, in block 64 of FIG. 4, may determine that at the completion of the simulated manufacturing processes, the evolved bubble defect 76 may cause a missing pattern defect, as shown in FIG. 5C.

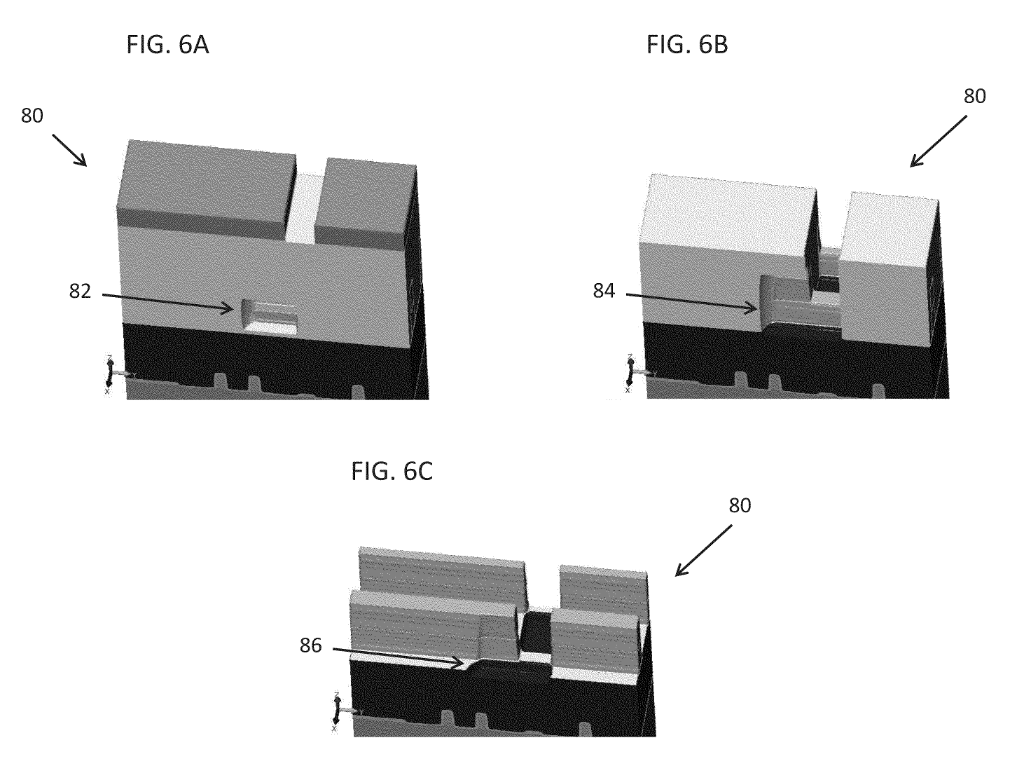

Referring now to FIG. 6A, in another iteration of blocks 54-62 of FIG. 4, another simulated virtual bubble defect 82 of the same shape, size and location as virtual defect 72 may be introduced in another simulated CMOS device 80 of the same design as device 70. However, the device 80 may be virtually inserted into a different manufacturing process module and a different sequence of manufacturing process steps may be simulated in another iteration of block 62 of FIG. 4. This sequence of manufacturing process steps may result in the evolution of the bubble defect 84, 86 shown in FIGS. 6B and 6C. Evaluation of the effects of the evolved bubble defect 86, in block 64 of FIG. 4, may determine that at the completion of these simulated manufacturing processes, the evolved bubble defect 86 may cause erosion along the gate, which likely would result in a flop-over.

The iterative introduction of the same hypothetical defect, and insertion at different modules of the manufacturing process flow, as shown in FIGS. 5A-5C and FIGS. 6A-6C, has narrowed the probable cause of the flop-over. Comparison of the detected flop-over, in block 66 of FIG. 4, with the results of the sequence of FIGS. 6A-6C has identified the virtual bubble defect 82 introduced at this process module as a likely cause of erosion along the gate that could result in the flop-over. On the other hand, comparison with the results of the sequence of FIGS. 5A-5C has eliminated the bubble defect 72, 74, 76 introduced at this process as a likely cause of the flop-over.

An inspection requirement at the manufacturing process module of FIG. 6A or at the manufacturing process module of FIG. 6B may be defined, in block 67 of FIG. 4, for early detection of a potential flop-over defect. Similarly, a hardware partition at the manufacturing process module of FIG. 6A or at the manufacturing process module of FIG. 6B may be requested, in block 67 of FIG. 4, to verify the cause of the flop-over. Information regarding the probable cause of the flop-over, that is, the bubble defect 82, 84, 86 of FIGS. 6A-6C, may be saved in a knowledge base for application in failure mode and effect analyses (FMEA) regarding future technologies and processes, in block 69 of FIG. 4.

An embodiment may eliminate improbable defect paths and reduce hardware commit for verification by virtually evaluating a root cause hypothesis. An embodiment may improve inspection recipe criteria by implementing a simulated defect model to establish correct criteria, such as defect size, shape, material, or the like, at a particular process sector. An embodiment may improve inspection test design split statistics by determining an optimal or near optimal split condition, as well as an optimal or near optimal inspection step for split evaluation. An embodiment may provide improved impact assessment based, for example, on the size and location of a defect.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for evaluating a defect in a device manufactured by a layering process, comprising:
generating, with a processing device, a first virtual defect in a first simulated model of the device; and
simulating a first manufacturing process associated with the device, wherein the first virtual defect is structurally transformed into a first evolved defect at least in part by the first manufacturing process.

2. The method of claim 1, wherein generating the first virtual defect further comprises:
specifying an initial size of the first virtual defect;
specifying an initial shape of the first virtual defect; and
specifying a material corresponding to the first virtual defect.

3. The method of claim 1, wherein generating the first virtual defect further comprises selecting a defect type from a library of predetermined defect types.

4. The method of claim 1, wherein the first virtual defect is simulated in three dimensions.

5. The method of claim 1, further comprising evaluating an effect of the first evolved defect after the simulation of the first manufacturing process.

6. The method of claim 1, further comprising incorporating the first virtual defect at a first location in the first simulated model.

7. The method of claim 6, further comprising:
generating a second virtual defect in a second simulated model of the device;
incorporating the second virtual defect at the first location in the second simulated model;
simulating the first manufacturing process, wherein the second virtual defect is structurally transformed into a second evolved defect at least in part by the first manufacturing process; and
comparing the first evolved defect with the second evolved defect.

8. The method of claim 6, further comprising:
generating the first virtual defect in a second simulated model of the device;
incorporating the first virtual defect at a second location in the second simulated model;
simulating the first manufacturing process, wherein the first virtual defect is structurally transformed into a second evolved defect at least in part by the manufacturing process; and
comparing the first evolved defect with the second evolved defect.

9. The method of claim 6, further comprising:
generating the first virtual defect in a second simulated model of the device;
incorporating the first virtual defect at the first location in the second simulated model;
simulating a second manufacturing process associated with the device, wherein the first virtual defect is structurally transformed into a second evolved defect at least in part by the first manufacturing process; and
comparing the first evolved defect with the second evolved defect.

10. The method of claim 1, further comprising:
detecting an actual defect in the device at a manufacturing process step; and
comparing the first evolved defect with the actual defect, wherein the first virtual defect is based on a hypothesis associated with the actual defect and the simulated first manufacturing process is upstream of the manufacturing process step.

11. The method of claim 1, further comprising:
detecting an actual defect in the device at a manufacturing process step; and
evaluating a yield impact of the first evolved defect, wherein the first virtual defect is based on the actual defect and the simulated first manufacturing process is downstream of the manufacturing process step.

12. The method of claim 1, further comprising storing the first virtual defect, the first simulated model, the simulated first manufacturing process and the first evolved defect in a knowledge base.

13. A system for evaluating a defect in a device manufactured by a layering process, comprising:
a virtual defect generator configured to generate a first virtual defect in a first simulated model of the device; and
a process simulator configured to simulate a first manufacturing process associated with the device, wherein the first virtual defect is structurally transformed into a first evolved defect at least in part by the first manufacturing process.

14. The system of claim 13, wherein the virtual defect generator is further configured to specify an initial size of the first virtual defect, an initial shape of the first virtual defect, and a material corresponding to the first virtual defect.

15. The system of claim 13, further comprising an effect evaluator configured to evaluate an effect of the first evolved defect after the simulation of the first manufacturing process.

16. The system of claim 13, wherein the process simulator is further configured to incorporate the first virtual defect at a first location in the first simulated model.

17. The system of claim 16, wherein the virtual defect generator is further configured to generate a second virtual defect in a second simulated model of the device, the process simulator is further configured to incorporate the second virtual defect at the first location in the second simulated model and simulate the first manufacturing process, the second virtual defect being structurally transformed into a second evolved defect at least in part by the first manufacturing process, and the effect evaluator is further configured to compare the first evolved defect with the second evolved defect.

18. The system of claim 16, wherein the virtual defect generator is further configured to generate the first virtual defect in a second simulated model of the device, the process simulator is further configured to incorporate the first virtual defect at a second location in the second simulated model and simulate the first manufacturing process, the first virtual defect being structurally transformed into a second evolved defect at least in part by the manufacturing process, and the effect evaluator is further configured to compare the first evolved defect with the second evolved defect.

19. The system of claim 16, wherein the virtual defect generator is further configured to generate the first virtual defect in a second simulated model of the device, the process simulator is further configured to incorporate the first virtual defect at the first location in the second simulated model and simulate a second manufacturing process associated with the device, the first virtual defect being structurally transformed into a second evolved defect at least in part by the first manufacturing process, and the effect evaluator is further configured to compare the first evolved defect with the second evolved defect.

20. A computer program product for evaluating a defect in a device manufactured by a layering process, the computer program product comprising:
a computer readable storage medium having stored thereon:
first program instructions executable by a processor to cause the processor to generate a first virtual defect in a first simulated model of the device; and
second program instructions executable by a processor to cause the processor to simulate a first manufacturing process associated with the device, wherein the first virtual defect is structurally transformed into a first evolved defect at least in part by the first manufacturing process.
